(19) United States
(12) Patent Application Publication
(10) Pub. No.: US 2011/0119351 A1
(43) Pub. Date: May 19, 2011

(54) CONTENT PROVIDING DEVICE AND PORTABLE TERMINAL DEVICE AND CONTENT SUBMISSION METHOD AND CONTENT MANAGEMENT METHOD

(75) Inventor: Tomofumi Tamura, Kanagawa (JP)

(73) Assignee: PANASONIC CORPORATION, Osaka (JP)

(21) Appl. No.: 13/054,766

(22) PCT Filed: Feb. 26, 2009
(86) PCT No.: PCT/JP2009/000869

§ 371 Date: Jan. 18, 2011

(30) Foreign Application Priority Data
Jul. 24, 2008 (JP) 2008-190894

(51) Int. Cl. G06F 15/16

(52) U.S. Cl. 709/217

(57) ABSTRACT

The object of the present invention is to enable a user to easily identify a provider of acquired contents from the contents. A mobile terminal includes a UPnP CP processing portion (100) for acquiring owner identification information of a content providing device, a phone book (107) for storing the owner identification information in association with owner information, a Media Transport Client processing portion (102) for acquiring contents from the content providing device, and a content management processing portion (106), when contents are acquired from the content providing device, with reference to the owner identification information of the content providing device that has been acquired by the UPnP CP processing portion (100), the owner identification information, and the owner information stored in the phone book (107), for identifying owner information of the content providing device, and storing the contents acquired in the content acquiring portion and the identified owner information which are associated to each other in the content storing portion (103).

### TECHNICAL FIELD

The present invention relates to a device (hereinafter, referred to as a “content providing device”) capable of accessing a home network in which electrical appliances, computers, accessories, or others in a home can be accessed through a network and having contents, a mobile terminal device which acquires contents from the content providing device, a content providing method, and a content management method.

### BACKGROUND ART

Recently, with the development of communication network technology or communication devices, digital electronic appliances equipped with network communication function, such as a HDD (Hard Disk Drive) recorder, a television, and a game device, etc., have been provided widely. Accordingly, in homes, a home network, which accesses these devices and a PC (Personal Computer) or other accessories for communication through a communication network, has begun to be provided.

In this home network, standardization for the purpose of allowing various devices such as digital electronic appliances, PCs, and mobile devices to seamlessly share contents such as music, photos, and videos has been promoted. As an example, there is the guideline (Home Network Device Interoperability Guideline) defined under DLNA (Digital Living Network Alliance) disclosed in Non-Patent Document 1. Hereinafter, this design guideline will be referred to as the “DLNA guideline.”

As a result of the DLNA guideline, in a home network, convenience and comfortableness are provided to a user. It is expected that the home network will be more universally provided in the future.

The DLNA guideline was established by selecting existing standard technology in order to realize high interconnectivity between devices in a home network. In the DLNA guideline, with regard to definition of a method of discovering and controlling a device or a method of searching and managing contents on a home network, UPnP (Universal Plug and Play) disclosed in Non-Patent Document 2 and UPnP AV (Audio Visual) disclosed in Non-Patent Document 3 are selected.

In the UPnP, a “service,” a “device,” and a “control point” are defined. The service is a logical unit for providing a predetermined service. The device is a logical unit having at least one service. The control point is a logical unit for controlling at least one service. Hereinafter, the device and the control point defined in the UPnP will be referred to as the “UPnP device” and the “UPnP control point,” respectively. The UPnP device and the UPnP control point perform notification of a service, state, or others and detection of a service by using SSDP (Simple Service Discovery Protocol). The notification of a service, state, or others is performed through transmission of an SSDP message. In the SSDP message, URL of a device description document (DDD) described by using XML (Extensible Markup Language) is included. DDD includes detailed information of a device, outline of a service to be provided, URL of a service description document (SDD), or others. SDD describes detailed information of a corresponding service.

The UPnP AV defines a device for AV Device control via a network, and an AV Service (AV Content replay control: Rendering Control) service, a content information providing (Content Directory) service, an AV Content transmission (AV Transport) service, or others. The UPnP AV Device defined by the UPnP AV provides the AV Service described above by means of an UPnP AV Message from an UPnP AV Control point.

A method for notification and detection of a service between the UPnP AV Device and the UPnP AV Control point will be described with reference to FIG. 13. FIG. 13 is a sequence for acquiring contents by the UPnP AV Control point, which is an example for a sequence when an UPnP AV Control point device acquires contents owned by an UPnP AV device. The UPnP AV device of FIG. 13 provides a Content Directory service.

First, when accessing a network, the UPnP AV Control point device acquires an IP address and performs device search processing by multicast transmitting an M-SEARCH message of SSDP to identify whether a desired device exists on the network (S10). Upon receiving the M-SEARCH message, the UPnP AV device returns an M-SEARCH response message to the UPnP AV Control point device if the UPnP AV device provides the service described in the M-SEARCH message (S11). The UPnP AV Control point device requests DDD to URL of the DDD included in the M-SEARCH response message and acquires the DDD. Likewise, SDD also is acquired. From the acquired DDD or SDD, an UPnP AV Content roll point device 1 is informed that the UPnP AV device provides the Content Directory service. The DDD or SDD includes detailed device information (device ID, a device name, and a maker name) of the UPnP AV device, or details of a service to be provided (S12 and S13).

The UPnP AV Control point device requests content list information BROWSE/SEARCH action of the Content Directory service) stored in the UPnP AV device to the UPnP AV device, and acquires the content list information. The content list information includes meta information (title, a type of a content, an artist, a genre, replaying time, and a preparation data, etc.) of each content, content URL, or others (S14 and S15). Thereafter, the UPnP AV Content roll point device requests that contents selected by a user be transmitted to the UPnP AV device. And, the UPnP AV Content roll point device acquires the selected contents (hereinafter, the term, “download” will be used to mean that the UPnP AVControl point device acquires contents from the UPnP AV device) (S16 to S18).

In FIG. 13, the UPnP AV Control point device acquires the contents stored in the UPnP AV device. However, the reverse case, i.e., providing contents stored in the UPnP AV Control point device to the UPnP AV device, also is possible. In that case, in S14 to S18 of FIG. 13, the UPnP AV Control point device transmits a Create Object action message, which includes content information desired to be provided, to the UPnP AV device, so as to add the content information to the content list information stored in the UPnP AV device. Thereafter, the UPnP AV Control point device transmits content data to the UPnP AV device (hereinafter, the term, “upload” will be used to mean that contents are provided from the UPnP AV Control point device to the UPnP AV device).

As described, upon accessing a home network, the UPnP AV Control point device can automatically discover the UPnP AV device that provides various services. In addition, through an UPnP AV Protocol, the UPnP AV Control point device and the UPnP AV device can share contents by way of download (or upload) of contents. Accordingly, a user who possesses the UPnP AV Control point device or the UPnP AV device can acquire desired contents on a home network and view the acquired contents anytime if the user wants to view the acquired contents.

[Non-Patent Document 1] DLNA Networked Device Interoperability Guidelines, Expanded: October 2006, DLNA

[Non-Patent Document 2] UPnP Device Architecture 1.0, Version 1.0. 1, May 6, 2003

[Non-Patent Document 3] UPnP AV Architecture: 0.83, Jun. 12, 2002

### DISCLOSURE OF THE INVENTION

### Technical Problem to be Solved by the Invention

However, if the user wants to identify acquisition source information of the acquired contents, it is difficult for the user to identify the acquisition source since the acquisition source information acquired from the content providing device includes only content URL. In addition, if the user wants to perform search based on an acquisition source of the contents, the user is required to input the content URL so that time is required.

In order to solve this problem, it has been considered to store content information in association with a device name and content data included in DDD to use the device name for acquisition information. In general, however, an identical device name is given to content providing devices which have an identical model code. As such, if contents are acquired from a plurality of content providing devices having an identical model code, it is impossible to distinguish the devices due to the identical device name. In addition, although a device name can be changed by a user of a content providing device, time is required for a user who owns the content providing device to change the device name, and in general, the change is not achieved. Moreover, in case of a content providing device, such as a mobile phone or a digital camera, of which device model is changed due to frequent repurchase, a device name is changed each time the device is changed, so that despite that contents have been acquired from an identical provider, the contents are regarded as have been acquired from different providers before and after the change of the content providing device.

The present invention has been made in consideration of this problem, and its object is to provide a mobile terminal device, which is capable of acquiring contents from a content providing device within a network and enabling a user to easily identify a provider of the acquired contents from the contents, and a method of managing the acquired contents.

The present invention provides a mobile terminal for acquiring contents from a content providing device through a network, the mobile terminal comprising:

an owner identification information acquiring portion, that detects the content providing device on the network by performing a device search processing when accessing the network, and acquires owner identification information of the content providing device;

an owner information storing portion that stores the owner identification information and owner information in association with each other;

a content acquiring portion that acquires contents from the content providing device;

a content storing portion that stores the contents acquired by the content acquiring portion; and

a content management processing portion that identifies owner information of the content providing device with reference to the owner identification information of the content providing device that has been acquired by the owner identification acquiring portion and the owner identification information and the owner information stored in the owner information storing portion when the contents have been acquired from the content providing device, and stores the contents acquired by the content acquiring portion and the identified owner information in association with each other in the content storing portion.

According to this configuration, from the acquired contents, a user can easily identify a provider of the contents.

Also, the present invention provides a content providing device for providing contents to a mobile terminal through a network, the content providing device comprising:

a content storing portion that stores contents;

an owner information management portion that stores owner identification information of the content providing device; and

a wireless communication portion, when receiving an owner identification information request from the mobile terminal, that transmits the owner identification information of the content providing device to the mobile terminal, and when receiving a content transmission request from the mobile terminal, that transmits contents to the mobile terminal that has transmitted the content transmission request.

According to this configuration, the mobile terminal enables a user to easily identify a provider of the acquired contents from the contents.

The present invention provides a content management method for managing contents acquired from a content providing device through a network, comprising:

when accessing a network, performing a device search processing to detect the content providing device on the network, and acquiring owner identification information of the detected content providing device;

storing the owner identification information and owner information so as to associated to each other; and

acquiring contents from the content providing device,

when the contents have been acquired from the content providing device, identifying the owner information of the content providing device with reference to the acquired owner identification information of the content providing device, the stored owner identification information and the stored owner information, and storing the contents acquired by the content acquiring portion and the identified owner information which are associated to each other in the content storing portion.

According to this sequence, from the acquired contents, a user can easily identify a provider of the contents.

The present invention provides content providing method for providing contents to a mobile terminal through a network, comprising:

storing contents and owner identification information of a content providing device; and

when an owner identification information request is received from the mobile terminal, transmitting the owner identification information of the content providing device to the mobile terminal, and when a content transmission request is received from the mobile terminal, transmitting contents to the mobile terminal that has transmitted the content transmission request.

According to this sequence, the mobile terminal enables a user to easily identify a provider of the acquired contents from the contents.

### EFFECTS OF THE INVENTION

According to the present invention, from the acquired contents, a user can easily identify a provider of the contents, and the user can easily manage and view the contents.

### BRIEF DESCRIPTION OF DRAWINGS

FIG. 1 is a view showing one example of a home network.

FIG. 2 is a block diagram of a mobile terminal 10 in Embodiment 1

FIG. 3 is a block diagram of a content providing device A 11 in Embodiment 1.

FIG. 4 is a sequence view when the mobile terminal 10 in Embodiment 1 downloads contents.

FIG. 5 is a flow chart of a storing process of contents by the mobile terminal 10 in Embodiment 1.

FIG. 6 is a block diagram of a mobile terminal 10 in Embodiment 2.

FIG. 7 is a block diagram of a content providing device 11B in Embodiment 2.

FIG. 8 is a sequence view when the mobile terminal 10 in Embodiment 2 uploads contents.

FIG. 9 is a flow chart for content management processing by the mobile terminal 10 in Embodiment 2.

FIG. 10 is a view showing one example of network configuration in Embodiment 3.

FIG. 11 is a block diagram of a mobile terminal 10 in Embodiment 3.

FIG. 12 is a sequence view showing content viewing notification and informing by the mobile terminal 10 in Embodiment 3.

FIG. 13 is a sequence view showing content acquisition by a conventional UPnP AV Control point.

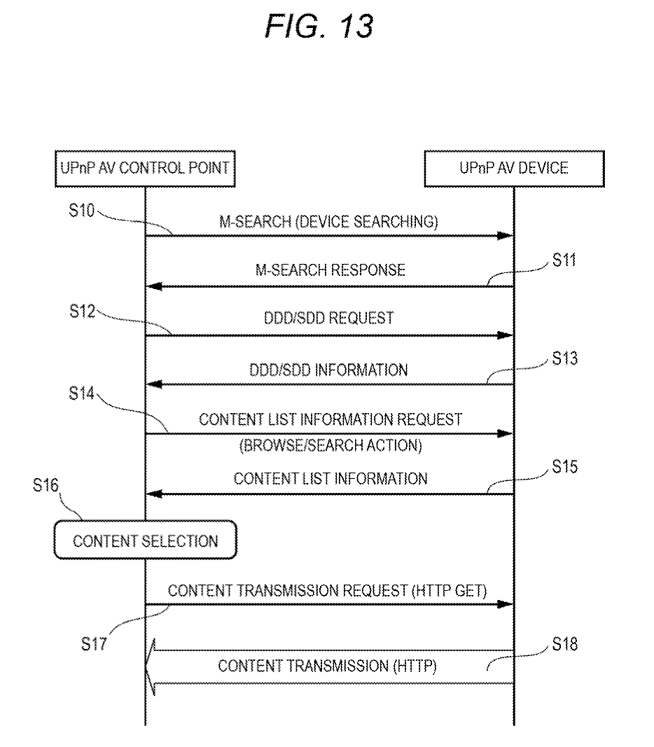

### DESCRIPTION OF REFERENCE NUMERALS

1 home network
10 mobile terminal
100 UPnP CP processing portion
101 MSCP processing portion
102 Media Transport Client processing portion
103 content storing portion
104, 300 control portion
105 device management portion
106 content management processing portion
107 phone book (user identification information storing portion)
108 display portion
109 operation portion
120 wireless communication portion
200 UPnP Device processing portion
201 MSD (UP) processing
202 Media Transport Server (UP) processing portion
203 device information management portion
204 content management processing portion
301 content management processing portion
302 notification processing portion
11, 12, 13 content providing device
110 UPnP Device processing portion
111 MSD processing portion
112 Media Transport Server processing portion
113 content storing portion
114 control portion
115 content list information management portion
116 device information management portion
117 owner information management portion
121 wireless communication portion
210 UPnP CP processing portion
211 MSCP (UP) processing
212 Media Transport Server (UP) processing portion
213 device management portion
214 content information providing management portion
14 WLAN router
2 Internet
24 mobile terminal (mobile terminal of another user)
25 desktop PC (desktop PC of another user)

### BEST MODE FOR CARRYING OUT THE INVENTION

Hereinafter, the best mode for carrying out the invention will be described with reference to the accompanying drawings.

### Embodiment 1

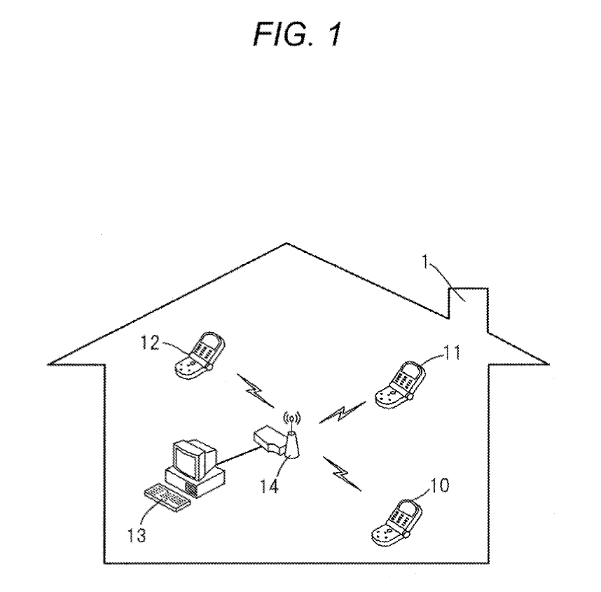

FIG. 1 is a view showing one example of network configuration in Embodiment 1 of the present invention. A home network 1 is configured by a mobile terminal 10, content providing devices 11 to 13, and a WLAN (Wireless Local Area Network) router 14. The mobile terminal 10 is equipped with a WLAN device so that it can access a WLAN router. The mobile terminal 10 is also equipped with UPnP AV Control function. In addition, the content providing device A 11, the content providing device B 12, and the content providing device C13 are equipped with UPnP AV Device function. The content providing device C13 is also equipped with the UPnP AV Control function. Meanwhile, Embodiment 1 describes an example case where the mobile terminal 10 downloads and manages contents which is managed by the content providing device A 11.

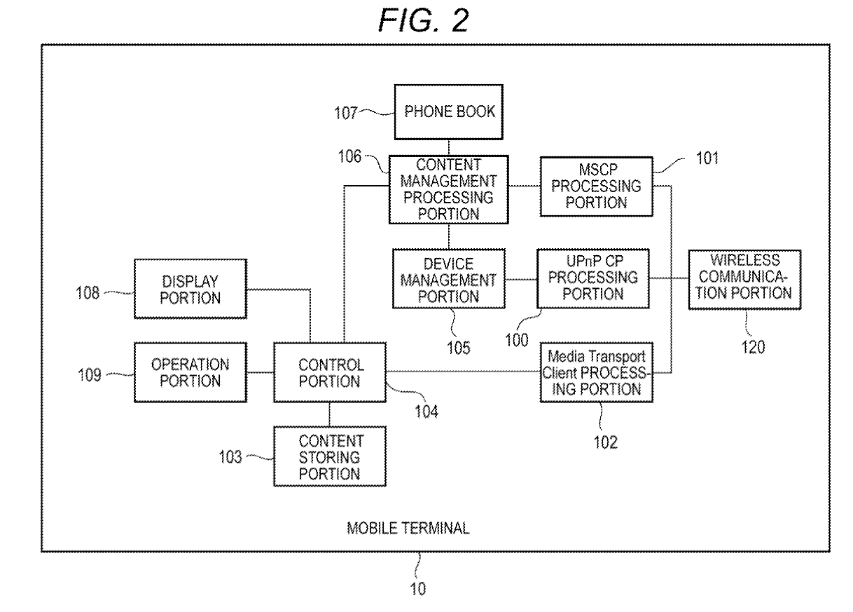

FIG. 2 is a block diagram showing configuration of the mobile terminal 10 in Embodiment 1 of the present invention. In FIG. 2, a wireless communication portion 120 is configured, for example, by a WLAN device and accesses a network through the WLAN router 14, and others, to perform transmission and reception of data with the content providing devices 11 to 13.

When the wireless communication portion 120 of the mobile terminal 10 accesses a network, the UPnP CP processing portion 100, which is an owner identification information acquisition portion, performs device search processing through the wireless communication portion 120 to detect a content providing device on the network, and acquires owner identification information such as DDD or SDD from the content providing device. The UPnP CP processing portion 100 provides the acquired owner identification information such as DDD or SDD to a device management portion 105.

A MSCP (Media Server Control Point) processing portion 101 performs UPnP AV Control point processing for the content providing device detected by the UPnP CP processing portion 100 from the content providing devices 11 to 13. Specifically, for the detected content providing device, the UPnP CP processing portion 101 transmits an action message of an AV Service, which is supported by the content providing device, through the wireless communication portion 120, controls the content providing device, and acquires content list information stored in the content providing device through the wireless communication portion 120. In addition, the UPnP CP processing portion 101 transmits the content list information acquired from the detected content providing device to a content management processing portion 106.

A Media Transport Client processing portion 102, which is a content acquisition portion, acquires content data designated by a control portion 104 from the content providing device through the wireless communication portion 120.

A content storing portion 103 acquires the content data acquired by the Media Transport Client processing portion 102 through the control portion 104 and stores the content data.

The control portion 104 displays content list information managed by the content management processing portion 106 on a display portion 108. If an operation portion 109 detects that contents have been selected from the displayed content directory by the user's operation through the operation portion 109, the control portion 104 acquires URL of the contents from the content management processing portion 106. Then, the control portion 104 notifies the URL to the Media Transport Client processing portion 102 to request acquisition of content data. In addition, if the Media Transport Client processing portion 102 has acquired the content data, the control portion 104 notifies completion of the content data acquisition to the content management processing portion 106. Furthermore, the control portion 104 controls the content storing portion 103 in accordance with a command from the content management processing portion 106 to perform creation of a folder in the content storing portion 103 or storing of the acquired content data in a certain folder.

The device management portion 105 analyzes the owner identification information, such as DDD or SDD, acquired by the UPnP CP processing portion 100, and stores and manages the information as device information of a content providing device. And, the device management portion 105 stores and manages owner identification information, such as a phone number or a mail address, for identification of an owner of a content providing device in correspondence to content device information. In addition, the device management portion 105 also stores device information (MAC address, a device name, or others) of the content providing device.

The content management processing portion 106 stores and manages the content list information acquired by the MSCP processing portion 101. The content management processing portion 106 downloads content data, which is selected by an operation of a user through the operation portion 109, from the content providing device. When receiving notification of the content acquisition completion from the control portion 104, the content management processing portion 106 acquires device information of the content providing device, from which the content data have been acquired, and owner identification information of the content providing device from the device management portion 105. The content management processing portion 106 stores and manages the information in association with the information of the contents that are being managed, with reference to identification information of a communication counterpart and a communication counterpart name managed in a phone book 107. Thereafter, the content management processing portion 106 commands a folder for storing the acquired content data to the control portion 104.

The phone book 107, which is an owner information storing portion, stores and manages identification information for identification of a communication counterpart such as a phone number or a mail address, and owner information such as a user name of the communication counterpart, other user information of the communication counterpart, photos or icons of the communication counterpart, and melody notified upon receiving a call from the communication counterpart. In addition, if a user has grouped communication counterparts, the phone book 107 stores and manages group names and grouped users in association with one another.

A display portion 108 is configured to include a display device such as LCD or organic EL, and displays various data such as content list information, communication counterpart information in the phone book, state of communication with a content providing device, reproducing of contents, or others.

The operation portion 109 is configured to include devices such as keys and touch panels, and displays various data such as content list information, communication counterpart information in the phone book, state of communication with a content providing device, reproducing of contents, or others.

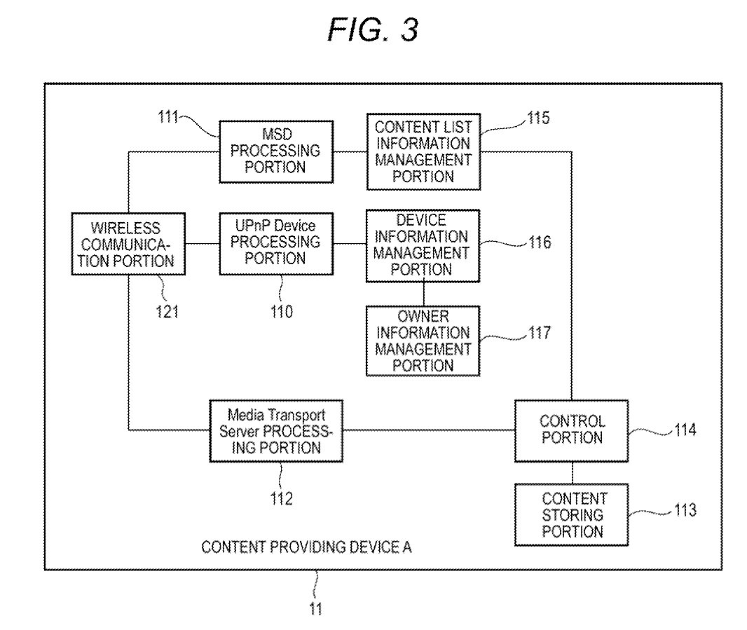

FIG. 3 is a block diagram showing configuration of the content providing device A 11 in Embodiment 1 of the present invention.

In FIG. 3, the wireless communication portion 121 is configured, for example, by a WLAN device, and accesses a network through a WLAN router, and others, to perform transmission and reception of data with the mobile terminal 10.

The UPnP Device processing portion 110 sends a response to M-SEARCH received by the wireless communication portion 121 from the mobile terminal 10, and transmits owner identification information such as DDD or SDD managed by the device information management portion 116 to the mobile terminal 10 through the wireless communication portion 121, in response to an owner identification information request such as a DDD or SDD request from the mobile terminal 10.

An MSD (Media Server Device) processing portion 111 performs processing of UPnP AV Device from the mobile terminal 10. Specifically, when receiving an action message of AV Service from the mobile terminal 10 through the wireless communication portion 121, the MSD processing portion 111 transmits the requested processing or content list information, which is managed by the content list information management portion 115, in the content providing device A 11 to the mobile terminal 10 through the wireless communication portion 121.

A Media Transport Server processing portion 112 acquires request contents stored in the content storing portion 113 through the control portion 114, based on a content transmission request received from the mobile terminal 10 through the wireless communication portion 121, and transmits them to the mobile terminal 10 through the wireless communication portion 121.

The content storing portion 113 stores content data.

The control portion 114 controls the content storing portion 113 to perform storing and reading of content data. In addition, the control portion 114 notifies content list information stored in the content storing portion 113 to the content list information management portion 115.

The content list information management portion 115 stores and manages information of the content directory stored in the content storing portion 113. In addition, the content list information management portion 115 stores information (file name, format, a title of a content, a writer, and location of a media source, etc.) of each content, which is notified from the control portion, in a list form, and provides the content information in accordance with a request from the MSD processing portion 111.

The device information management portion 116 stores and manages DDD, which describes detailed device information (device ID, a device name, and a maker name) of the content providing device A 11 or service information to be provided, or SDD, which describes detailed information of a service. In addition, the device information management portion 116 acquires owner identification information of the content providing device A 11, which is managed by the owner information management portion 117, and includes the information as an information element of DDD.

The owner information management portion 117 manages owner information (identification information such as a name, a phone number, or a mail address, group property information, and an address, etc.) of the content providing device A 11.

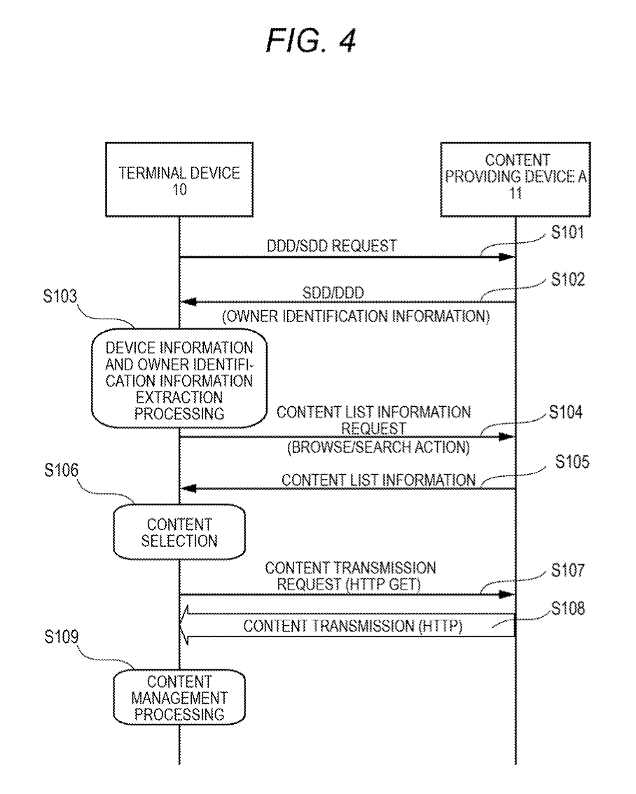

Next, access performance in the configuration of Embodiment 1 of the present invention will be described with reference to FIG. 4. FIG. 4 is an access sequence when the mobile terminal 10 downloads contents from the content providing device A 11, in the network configuration shown in FIG. 1. Meanwhile, in FIG. 4, the mobile terminal 10 detects the content providing device A 11 by transmitting M-SEARCH.

Processing when the mobile terminal 10 downloads contents selected by a user from the content providing device A 11 will be described. First, the mobile terminal 10 requests DDD or SDD to the detected content providing device A 11, and acquires the DDD or SDD stored in the content providing device A 11. In this case, in the content providing device A 11, the device information management portion 116 acquires owner identification information from the owner information management portion 117 to add the information to DDD or SDD, and transmits the DDD or SDD to the mobile terminal 10 through the UPnP Device processing portion 110 (S101 and S102).

The mobile terminal 10 analyzes the DDD or SDD acquired from the content providing device A 11, by the device management portion 105, and extracts and stores device information of the content providing device A 11 and owner identification information of the content providing device A 11 (S103).

Thereafter, the mobile terminal 10 transmits a content list information request message (BROWSE/SEARCH action) to the content providing device A 11, acquires content list information in the content providing device A 11, and stores it in the content management processing portion 106 (S104 and S105).

If a user of the mobile terminal 10 has selected contents that he/she wants to acquire from the content list information, the mobile terminal 10 requests the content providing device A 11 to transmit the contents, and the content data is downloaded from the content providing device A 11 (S106 to S108). When receiving content data, the mobile terminal 10 performs content management processing, and stores the content data in the mobile terminal (S109).

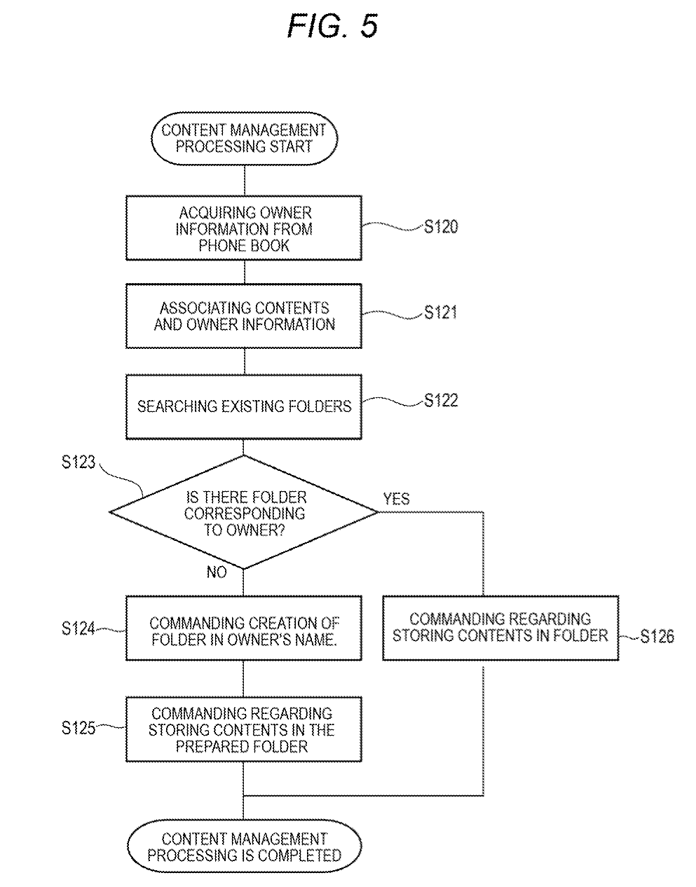

Next, content management processing in the mobile terminal 10 will be described with reference to FIG. 5. When the mobile terminal 10 acquires content data from the content providing device A 11, the content management processing portion 106, which have received notification of content data acquisition completion from the control portion 104, starts content management processing. First, the content management processing portion 106 acquires device information and owner identification information of the content providing device A 11, which are stored in the device management portion 105, and based on the owner identification information, acquires owner information (user name, group name, or others) from the phone book 107 (S120). Next, the content management processing portion 106 associates the owner information acquired from the phone book 107, the device information acquired from the device management portion 106, and the stored information of the acquired contents, etc. (S121). In addition, the content management processing portion 106 acquires a directory of folders existing in the content storing portion 103 from the control portion 104 (S122).

Next, the content management processing portion 106 identifies, from the folder list information, whether a folder corresponding to an owner associated with the acquired contents exists in the content storing portion 103 (S123). If no corresponding folder exists, the content management processing portion 106 creates a new folder, whose folder name is the owner name of the owner information, and requests the control portion 104 to store the content data acquired from the content providing device A 11 in the folder (S124 and S125). If a corresponding folder exists, the content management processing portion 106 requests the control portion 104 to store the acquired content data in the folder (S126).

As described, according to the configuration of Embodiment 1, the mobile terminal 10 manages contents downloaded from the content providing devices 11 and 12 in association with owner information of the content providing device, which is registered in the phone book of the mobile terminal. As such, it is possible to provide a user with a provider name (owner name of the content providing device that has provided contents) as provider information of the acquired contents. Accordingly, the user can easily identify the acquisition source of the contents. Further, since the downloaded contents are managed so as to be automatically sorted by each provider name, the user does not need to perform arrangement works such as folder creating or content movement for acquired contents so that the user can easily manage and view the contents.

### Embodiment 2

Next, Embodiment 2 of the present invention will be described with reference to the drawings.

The network configuration of Embodiment 2 is the same as FIG. 1 shown in Embodiment 1. Embodiment 2 is different from the configuration of Embodiment 1 in that the mobile terminal 10 of Embodiment 2 does not download contents from the content providing device A 11, and is equipped with UPnP AVDevice function, such that contents are uploaded from the content providing device B 12. The other configuration and processing performance are identical. The same configuration and processing performance as those described in Embodiment 1 will be denoted by the same reference numerals as used in Embodiment 1, and explanation thereof will be omitted.

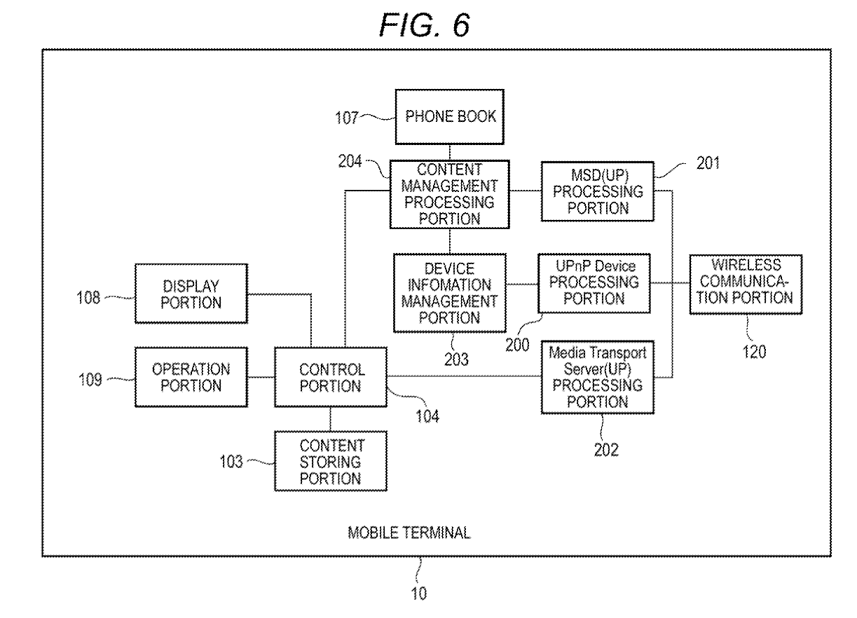

FIG. 6 is a block diagram showing configuration of the mobile terminal 10 in Embodiment 2. The blocks denoted by the same reference numerals as used for the mobile terminal 10 of FIG. 2 will not be described since the same processes as those of Embodiment 1 are performed. Processing portions denoted by different reference numerals will be described.

The UPnP Device processing portion 200 responds to M-SEARCH from the content providing device B 12, and provides DDD or SDD managed by the device information management portion 203 in response to a DDD or SDD request from the content providing device B 12.

The MSD (UP(Upload)) processing portion 201 performs processing of UPnP AV Device from the content providing device B 12. Specifically, in accordance with a Create Object action message of AV Service from the content providing device B 12, the MSD (UP) processing portion 201 requests the content management processing portion 204 to add content information in the message to content list information. If completion of the content list information addition has been notified from the content management processing portion 204, the MSD (UP) processing portion 201 transmits the completion notification to the content providing device B 12.

The Media Transport Server (UP) processing portion 202 receives content data from the content providing device B 12, and commands the control portion 104 to transmit the content data to the content storing portion 103.

The device information management portion 203 manages DDD, which describes detailed device information (device ID, a device name, and a maker name) or information of a service to be provided, and SDD, which describes detailed information of a service.

The content management processing portion 204 manages list information of contents stored in the mobile terminal 10. If a content information addition request has been made from the MSD(UP) processing portion 201, the content management processing portion 204 adds the content information to the content list information, and sends a response to the MSD(UP) processing portion. In that case, the content management processing portion 204 extracts owner identification information of the content device B 12 from the content information, acquires information (communication counterpart name, a group name, or others) corresponding to the owner identification information from the phone book 107, and associates the information with the content information. If completion of the content data acquisition is notified from the control portion 104, the content management processing portion 204 performs the content management processing that is described later, and commands a folder for storing the acquired content data to the control portion 104.

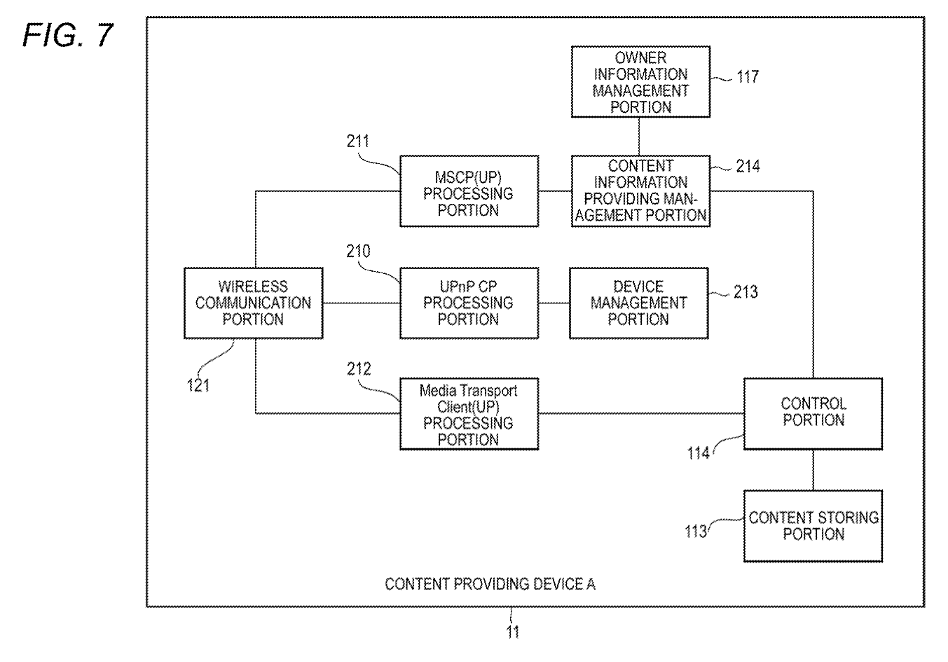

FIG. 7 is a block diagram showing configuration of the content providing device B 12 in Embodiment 2. The blocks denoted by the same reference numerals as used for the content providing device B 12 of FIG. 3 will not be described since the same processes as those of the content providing device A 11 of Embodiment 1 are performed. Processing portions denoted by different reference numerals will be described.

When the content providing device B 12 has accessed a network, the UPnP CP processing portion 210 performs a device search process to detect the mobile terminal 10 having UPnP AV Device function on the network, and acquires DDD or SDD from the mobile terminal 10.

The MSCP (UP) processing portion 211 performs UPnP AV Control point processing for the detected mobile terminal 10. Specifically, the MSCP (UP) processing portion 211 transmits a Create Object action message of AV Service to the mobile terminal 10, and requests addition of the content information stored in the content providing device B 12 to content list information of the mobile terminal 10. If a content information addition response has been made from the mobile terminal 10, the MSCP (UP) processing portion 211 notifies it to the content information providing management portion 214.

The Media Transport Client (UP) processing portion 212 acquires content data designated by the control portion 114 from the content storing portion 113, and transmits the data to the mobile terminal 10.

The device management portion 213 analyzes DDD or SDD of the mobile terminal acquired by the UPnP CP processing portion 210, and manages it as device information of the mobile terminal 10.

The content information providing management portion 214 manages content list information stored in the content providing device B 12. If a user has selected contents to be uploaded to the mobile terminal 10, the content information providing management portion 214 acquires owner identification information from the owner information management portion 117, adds it to the content information, and requests the MSCP (UP) processing portion 211 to transmit a content information addition request to the mobile terminal 10. If a content information addition response has been notified from the MSCP (UP) processing portion 211, the content information providing management portion 214 commands the control portion 114 to transmit the contents to the mobile terminal 10.

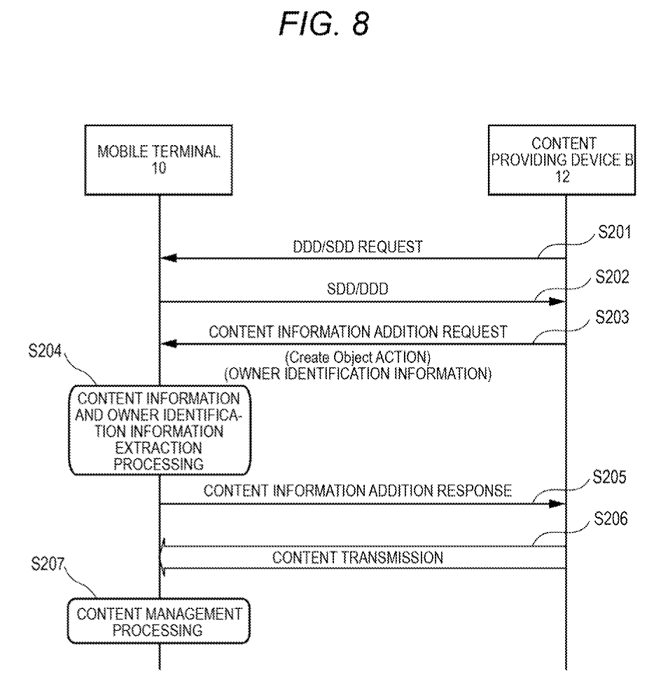

Next, content acquisition performance in the configuration will be described with reference to FIG. 8. Specifically, processing when the content providing device B 12 uploads contents to the mobile terminal 10 will be described.

FIG. 8 is an access sequence when contents are uploaded from the content providing device B 12 to the mobile terminal 10, in the network configuration shown in FIG. 1. Meanwhile, in FIG. 8, the content providing device B 12 detects the mobile terminal 10 through transmission of M-SEARCH.

First, the content providing device B 12 requests DDD or SDD to the detected mobile terminal 10, and acquires the DDD or SDD stored in the mobile terminal 10 (S201 and S202).

If a user has selected contents that he/she wants to provide to the mobile terminal 10, the content providing portion B12 acquires owner identification information from the owner information management portion 117 by the content information providing management portion 214, and adds it to the content information. Thereafter, in order to add the content information to the content list information stored in the mobile terminal 10, the content providing portion B12 transmits a content information addition request message (Create Object action) (S203).

When receiving the content information addition request message, the mobile terminal 10 extracts content information and owner identification information by the content management processing portion 204, and acquires information (communication counterpart name, a group name, or others) corresponding to the owner identification information from the phone book 117 to associate the information with the content information. In addition, the content management processing portion 204 registers the content information in the content list information to be stored (S204).

If the content information addition has been successfully performed by the content management processing portion 204, a response is transmitted to the content providing device B 12 through the MSD(UP) processing portion 201 (S205).

When receiving the content information addition response message from the mobile terminal 10, the content providing device B 12 uploads the content data to the mobile terminal 10 (S206).

When receiving the content data, the mobile terminal 10 performs content management processing, and stores the content data in the mobile terminal (S207).

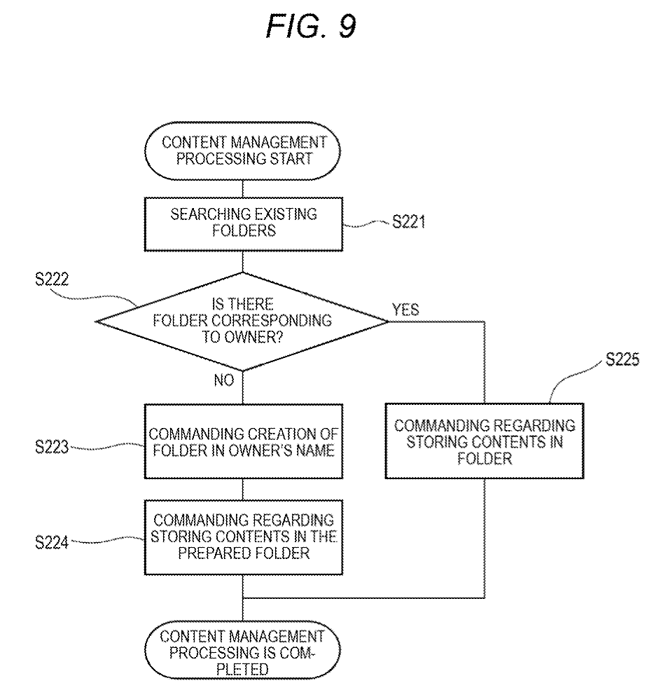

Next, content management processing in the mobile terminal 10 will be described with reference to FIG. 9.

When receiving notification of the content data acquisition completion from the control portion 104, the content management processing portion 204 acquires a directory of folders existing in the content storing portion 103 from the control portion 104 (S221).

The content management processing portion 106 detects, from the folder list information, whether a folder corresponding to the owner associated with the acquired contents exists in the content storing portion 103 (S222). If no corresponding folder exists, the content management processing portion 106 prepares a new folder, in which a folder name is the owner name of the owner information, and requests the control portion 104 to store the content data acquired from the content providing device B 12 in the folder (S223 and S225). If a corresponding folder exists, the content management processing portion 106 requests the control portion 104 to store the acquired contents in the folder (S225).

As described, according to the configuration of the embodiment, the mobile terminal manages contents uploaded from the content providing device in association with owner information of the content providing device registered in the phone book of the mobile terminal. As such, as in Embodiment 1, it is possible to provide a user with a provider name as provider information of acquired contents. The user can easily identify the acquisition source of the contents. Further, since uploaded contents are managed so as to be automatically sorted by each owner name, the user does not need to perform arrangement works (folder making, content movement, or others) for acquired contents, so that the user can easily mange and view the contents.

Meanwhile, in Embodiments 1 and 2 that have been described, although the mobile terminal automatically sets an automatically created folder name, the folder name may be changed by a user. In that case, contents acquired from the content providing device may be automatically sorted based on owner information of the content providing device.

In addition, although an owner name of the content providing device is used for a folder name, a group name or other user information registered in a phone book may be used. In that case, contents acquired from the content providing device may be sorted in each folder based on the information used for the folder name.

### Embodiment 3

Next, Embodiment 3 of the present invention will be described with reference to the drawings.

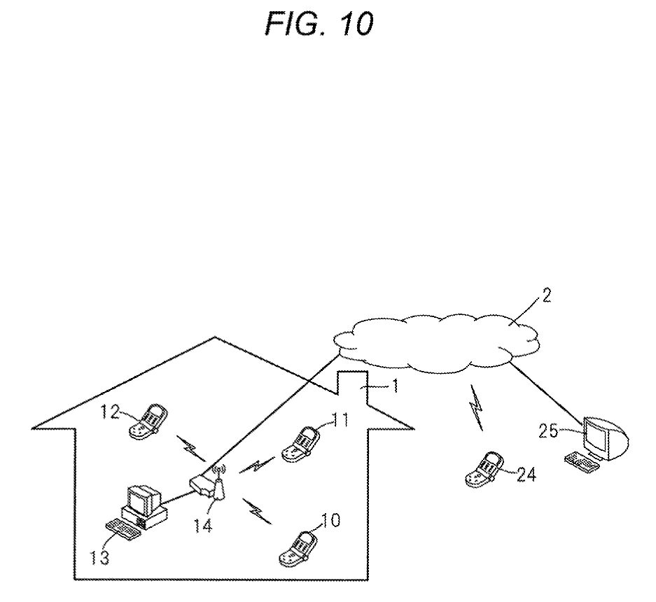

FIG. 10 shows network configuration of Embodiment 3. As shown in FIG. 10, in Embodiment 3, a home network 1 may additionally access a mobile terminal A 24 of another user, a desktop PC 25 of another user, and others, through Internet 2, in addition to the home network 1 described in Embodiments 1 and 2.

In addition, Embodiment 3 is different from Embodiments 1 and 2, in that in addition to the performances in Embodiments 1 and 2, a user notifies viewing state, appraisal, appreciation, or others of contents acquired from a certain content providing device to an owner or another user of the content providing device.

The other configuration and processing performance in Embodiment 3 are the same as Embodiments 1 and 2. The same configuration and processing performance as the configuration and the processing performance described in Embodiments 1 and 2 will be denoted with the same reference numerals as used in Embodiments 1 and 2, and explanation thereof will be omitted.

Meanwhile, Embodiment 3 describes that when a user of the mobile terminal 10 has viewed contents acquired from the content providing device A 11, viewing state, appraisal, appreciation, or others of the contents are notified to the content providing device A 11 or another user.

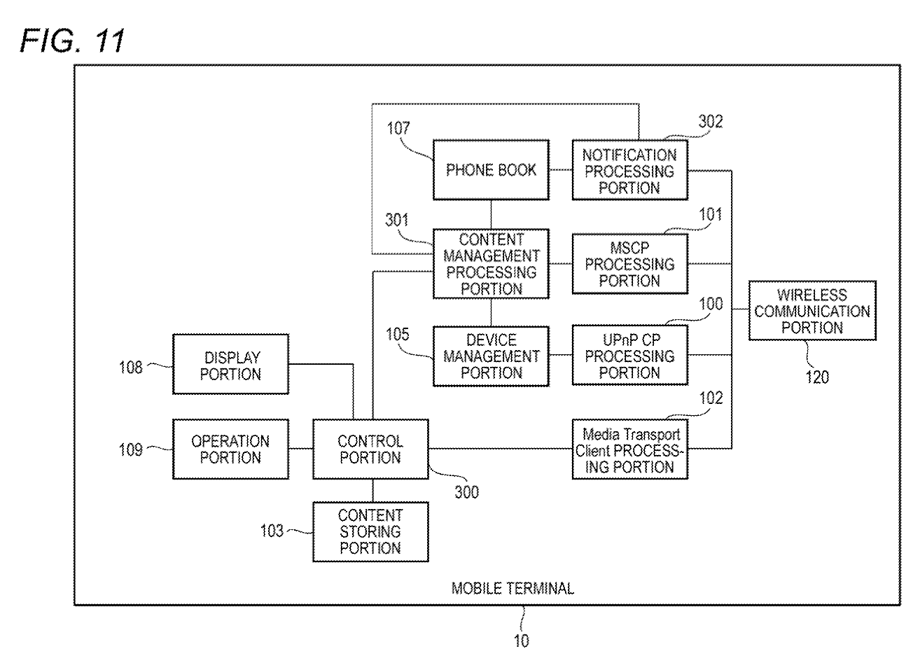

FIG. 11 is a block diagram of the mobile terminal 10 in this embodiment. The blocks denoted by the same reference numerals as used in FIG. 2 will not be described since the same processes as those in Embodiment 1 are performed. Processing portions denoted with different reference numerals will be described.

The control portion 300 controls the content storing portion 103 in accordance with a command from the content management processing portion 301, and performs storing the acquired content data. In addition, if a user has viewed contents stored in the content storing portion 103, the control portion 300 notifies the content management processing portion 301 that the contents have been viewed.

The content management processing portion 301 manages content list information acquired by the MSCP processing portion 101. The management processing portion 301 downloads content data selected by a user, and when receiving notification of content acquisition completion from the control portion 300, the management processing portion 301 acquires device information of the content providing device A 11 and owner identification information of the content providing device A 11. And, with reference to identification information and communication counterpart names managed in the phone book 107, the management processing portion 301 performs associating the information with information of the contents that are being managed, and manages the information. Thereafter, the management processing portion 301 commands a folder for storing the acquired content data to the control portion 300. When receiving content viewing notification from the control portion 300, the management processing portion 301 changes the content viewing state to the state that viewing has been finished, and manages user's appraisal, appreciation, or others of the contents in association with the content information. In addition, the management processing portion 301 transmits content information including user's appraisal, appreciation, or others to the notification processing portion 302, and requests the notification processing portion 302 to inform the content viewing to the content providing device A 11 or another user.

When receiving the content viewing informing request from the content management processing portion 301, the notification processing portion 302 extracts owner information of the content providing device A 11 from the content information. Thereafter, the notification processing portion 302 acquires the owner identification information (phone number or a mail address) from the phone book 107, specifies a group to which the owner of the content providing device A 11 belongs, and acquires identification information (phone number or a mail address) of members in the group. Based on the acquired identification information, the notification processing portion 302 notifies a content viewing message, which includes user's appraisal, appreciation, or others of the contents, to the content providing device A 11 or each member in the group through electronic mails or SMS (Short Message Service).

The configuration of the content providing device A 11 is the same as the configuration shown in FIG. 3.

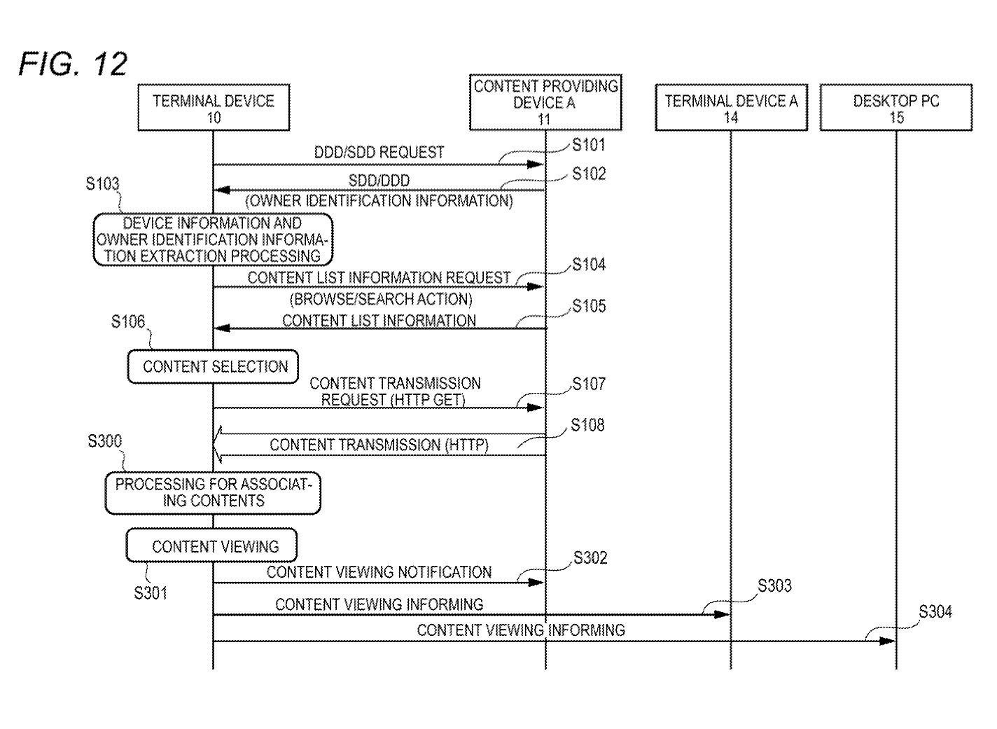

Next, the performance in the configuration of Embodiment 3 will be described with reference to FIG. 12. FIG. 12 is a sequence when the mobile terminal 10 notifies content viewing state to the content providing device A 11, the mobile terminal A24 of another user, and desktop PC 25 of another user, in the network configuration shown in FIG. 10. Meanwhile, in the phone book 107 of the mobile terminal 10, users of another user's mobile terminal A24 or another user's desktop PC 25 are registered in a group to which a user of the content providing device A 11 belongs.

Since S101 to S108 of FIG. 12 are the same as those of FIG. 4, explanations thereof are omitted.

The mobile terminal 10, which has downloaded content data, performs content associating processes by the content management processing portion 301, and stores the content data in the content storing portion 103 of the mobile terminal 10 (S300). The content associating processes are performed in the manner that the content management processing portion 301 acquires device information and owner identification information of the content providing device A 11, from which the content data have been acquired, from the device management portion 105, and associates the information with the information of the contents with reference to identification information and communication counterpart names managed by the phone book 107. After finishing the content associating processes, the content data are stored in the content storing portion 103.

If a user has viewed the contents stored in the content storing portion 103, the content viewing is notified from the control portion 300 to the content management processing portion 301. The content management processing portion 301 changes the content viewing state to the state that viewing has been finished, adds user's appraisal, appreciation, or others to the content information, and requests the notification processing portion 302 to inform the content viewing (S301).

The communication processing portion 302 acquires owner identification information of the content device A 11 from the phone book 107, specifies a belonging group, and acquires identification information of the mobile terminal A14 and the desktop PC 15 belonging to the group. In addition, based on the acquired owner identification information of the content device A 11, the communication processing portion 302 transmits a content viewing notification message to the content providing device A 11 (S302). In addition, the communication processing portion 302 also informs a content viewing information message to the mobile terminal A 14 and the desktop PC 15, which belong to the group. The content viewing notification message or the content viewing informing message includes content appraisal, appreciation, or others by a user who owns the mobile terminal 10 (S303).

As described, according to the configuration of the embodiment, the mobile terminal manages contents acquired from the content providing device in association with owner information of the content providing device registered in the phone book of the mobile terminal, as in Embodiments 1 and 2. As a result, a user can easily identify the acquisition source of the contents, and can easily manage and view the contents.

In addition, if acquired contents have been viewed, appraisal, appreciation, or others of the contents are notified to the provider through electronic mails or SMS, so that the provider can easily identify viewing state of the contents, and user convenience can be improved. Further, it is possible to inform appraisal or appreciation of viewed contents to each member of a group, which is registered in a phone book, other than the provider, and a user can recommend the contents to each member of the group.

Meanwhile, according to Embodiments 1 to 3, acquired contents are associated with information in a phone book, so that a user can reference content list information acquired from the phone book. In addition, it is possible for a user to input and search a provider name from all contents in the mobile terminal, thereby implicatively displaying contents acquired from the provider.

In addition, in Embodiments 1 to 3 that have been described, the content providing device provides owner identification information as an information element of DDD or SDD or an information element of content list information. However, the present invention is not limited thereto. For example, after acquiring DDD or SDD of the content providing device, the mobile terminal may request owner identification information to the content providing device, and acquire owner identification information in response.

In addition, in Embodiments 1 to 3 that have been described, an ad hoc mode, instead of an infrastructure mode of wireless LAN, may be applied.

In addition, in Embodiments 1 to 3 that have been described, WLAN is described as an example of a wireless access method. However, the present invention is not limited thereto, and Bluetooth may be applied. In addition, although an infrastructure mode is employed as a WLAN communication mode, an ad hoc mode may be applied.

In addition, in Embodiments 1 to 3 that have been described, an automatically created folder name may be changed by a user.

In addition, in Embodiments 1 to 3 that have been described, an automatically created folder name may be a group name set in the phone book, instead of an owner name. In that case, in the folder, contents acquired from a provider belonging to the group are stored.

The present invention has been described in detail with reference to particular embodiments. However, it is apparent to one of ordinary skill in the art that various modifications or corrections may be added without departing from the spirit and scope of the present invention.

The present application is based on a Japanese patent application (Japanese Patent Application No. 2008-190894) filed on Jul. 24, 2008, the contents of which are herein incorporated by reference.

### INDUSTRIAL APPLICABILITY

According to the present invention, from acquired contents, a user can easily identify a provider of the contents, and can easily manage and view the contents. As such, the present invention is promising to provide a content providing device, a mobile terminal device, a content providing method, and a content managing method.

1. A mobile terminal for acquiring contents from a content providing device through a network, the mobile terminal comprising:
an owner identification information acquiring portion, that detects the content providing device on the network by performing a device search processing when accessing the network, and acquires owner identification information of the content providing device;
an owner information storing portion that stores the owner identification information and owner information in association with each other;
a content acquiring portion that acquires contents from the content providing device;
a content storing portion that stores the contents acquired by the content acquiring portion; and
a content management processing portion that identifies owner information of the content providing device with reference to the owner identification information of the content providing device that has been acquired by the owner identification acquiring portion and the owner identification information and the owner information stored in the owner information storing portion when the contents have been acquired from the content providing device, and stores the contents acquired by the content acquiring portion and the identified owner information in association with each other in the content storing portion.

2. The mobile terminal according to claim 1, wherein the content management processing portion commands the content storing portion to create a folder corresponding to the owner information of the content providing device, and stores the acquired contents in the folder corresponding to the owner information.

3. The mobile terminal claimed according to claim 1, comprising:
a notification processing portion, after contents are viewed, that notifies viewing state, appraisal, or appreciation of the contents to the content providing device corresponding to the owner information associated with the contents.

4. (canceled)

5. A content management method for managing contents acquired from a content providing device through a network, comprising:
when accessing a network, performing a device search processing to detect the content providing device on the network, and acquiring owner identification information of the detected content providing device;
storing the owner identification information and owner information so as to be associated to each other; and
acquiring contents from the content providing device,
when the contents have been acquired from the content providing device, identifying the owner information of the content providing device with reference to the acquired owner identification information of the content providing device, the stored owner identification information and the stored owner information, and storing the contents acquired by the content acquiring portion and the identified owner information which are associated to each other in the content storing portion.

6. (canceled)
